(19) United States
(12) Patent Application Publication
(10) Pub. No.: US 2021/0293057 A1
(43) Pub. Date: Sep. 23, 2021

(54) Locking System and Method of Actuating a Locking System

(71) Applicant: Huf Hülsbeck & Fürst GmbH & Co. KG, Velbert (DE)

(72) Inventors: Igor Gorenzweig, Wuppertal (DE); Stefan Mönig, Schwelm (DE); Sven Hild, Hagen (DE)

(21) Appl. No.: 17/252,533

(22) PCT Filed: May 17, 2019
(86) PCT No.: PCT/EP2019/062761

§ 371 Date: Dec. 15, 2020

(30) Foreign Application Priority Data
Jun. 28, 2018 (DE) 10 2018 115 635.9

(51) Int. Cl. E05B 77/02; E05B 79/20; E05B 81/76; E05B 81/78; E05B 83/36; E05B 85/00; B60R 25/24; B60R 25/31

(52) U.S. Cl. CPC E05B 77/02; E05B 79/20; E05B 81/77; B60R 25/31; E05B 83/36; E05B 85/01; B60R 25/24; E05B 81/78

(57) ABSTRACT

The invention relates to a locking system (100) for a movable part (101), in particular a door or a lid, of a vehicle, comprising: a handle (10) fixed relative to the movable part (101) in a normal operation of the vehicle for opening or closing the movable part (101), a lock (20) for locking or unlocking the movable part (101), and an actuator (30) for actuating the lock (20). According to the invention, the actuator (30) can be arranged at a distance from the lock (20).

The present invention relates to a locking system for a movable part, in particular a door or a lid, of a vehicle according to the preamble of the independent device claim, which is designed with a fixed handle for opening or closing the movable part. Furthermore, the invention relates to a method for actuating a corresponding locking system according to the preamble of the independent method claim.

Known locking systems for motor vehicles can comprise movable handles that can be moved between a locking position and an extended opening position. In the opening position of the movable handle the movable part can be opened. Locking systems with fixed handles are also known. The fixed handles are designed to open the movable part without any active actuation, i.e. without moving the handle by activating another sensor on the fixed handle or by simply pulling the movable part with it.

In both cases, the locking systems can comprise a lock to lock or unlock the movable part. The locking systems can also communicate with automatic security systems, which together can form active or passive keyless-entry or keyless-go systems. Such systems allow the lock to be locked or unlocked without the active intervention of an authorized driver. Such systems can also release the movable part for an opening movement or even open it automatically, e.g. if the movable part can be moved to the opening position in a spring elastic manner. To communicate with the security system, the driver must carry an electronic key in the form of an ID-transmitter to identify himself to the security system. Usually proximity sensors are used in such handles, which first detect the presence of a user and then start an identification request to verify the user's authorization. The security system can communicate with the ID-transmitter to request an identification code. If there is no correct answer, nothing happens and the security system switches back to standby. Pulling on the movable handle will then have no effect because the lock has not been unlocked by the locking system. However, if authentication is successful, the locking system unlocks the lock, allowing the movable part to be opened by means of a movable or fixed handle. Alternatively, the vehicle can be opened with a remote control, which is usually integrated in the keyless-entry key.

Locking systems with movable handles have the disadvantage that the operation of the locking systems is not as convenient as that of locking systems with fixed handles. For locking systems with fixed handles, the problem arises in an emergency if the vehicle battery is discharged and/or the electronic system fails so that the automatic actuation of the lock is not possible.

It is therefore an object of the present invention to at least partially overcome the disadvantages described above. On the one hand, it is an object of the present invention to provide a locking system for a movable part, in particular a door or a lid, of a vehicle, which allows an upgrade of locking systems with movable handles in order to provide the same advantages as those associated with fixed handles. On the other hand, it is an object of the present invention to provide a locking system with fixed handles which ensures a safe opening of the movable part in an emergency.

The preceding object is solved by all features of the independent device claim as well as by all features of the independent method claim. Further advantages and details of the invention result from the respective dependent claims, the description and the figures. Advantages and details which are described in connection with the inventive locking system are of course also valid in connection with the inventive method and vice versa, so that with regard to the disclosure of the individual aspects of the invention reference is or can always be made to each other.

The invention provides a locking system for a movable part, in particular a door or a lid, of a vehicle, which comprises a handle a handle fixed relative to the movable part in a normal operation of the vehicle for opening or closing the movable part, a lock for locking or unlocking the movable part, and an actuator for actuating the lock, in particular for opening the movable part. According to the invention, it is intended for this purpose that the actuator can be arranged at a distance from the lock.

A locking system in the sense of the invention can be understood as an automatically controllable system that can communicate with a security system of the vehicle. In other words, the locking system in the sense of the invention can be designed as an intelligent locking system which, after a positive request of a user's authorization and subsequent unlocking of the lock, can open the movable part by means of the actuator (normal operation) or the handle (emergency operation). The authorization request and the unlocking of the lock can be performed or initiated by the vehicle's security system, for example. The locking system according to the invention ensures that the lock is actuated to open the movable part. The locking system can thus form part of a keyless-go system or a keyless-entry system. In a normal operation, the actuator is provided to actuate the lock or to open the movable part. The actuator can correspondingly actuate the lock to open the movable part. The actuator may comprise an electric motor that can be controlled by electric signals. The electric signals can advantageously be transmitted wirelessly, e.g. by means of electromagnetic waves, in particular by radio. In emergency operation, on the other hand, the handle is designed to open the movable part of the vehicle mechanically. In a normal operation of the vehicle the handle does not move (function—fixed handle). In emergency operation, the handle is moved (function—movable handle) to enable emergency opening of the movable part by mechanical actuation or movement of the handle.

The inventive idea here is that the actuator is provided spatially separated from the lock. In other words, the actuator is provided as a separate unit that does not need to be installed in the housing of the lock. The actuator can be fixed at a remote location where space is available. The invention has several significant advantages. Firstly, a simple and inexpensive mechanical lock can be used within the scope of the locking system according to the invention. On the other hand, the available space at the installation site, e.g. under an interior lining of a vehicle door or behind a vehicle lid, can be used flexibly. Furthermore, it is advantageous that a, preferably flexible, transmission chain can be created between the actuator, the lock and the handle, which can be adapted to almost any structural conditions on site. A flexible and/or deformable transmission element, e.g. in the form of a Bowden cable, can be provided for this purpose. It is also advantageous that the locking system can use the advantages of the fixed handle during normal operation of the vehicle and still provide a safe, in particular mechanical, emergency opening function in an emergency with the same handle.

Advantageously, the locking system in the sense of the invention can be used as a retrofit system for vehicles which already comprise mechanical locks and movable handles. By retrofitting the actuator and the fixed handle in the sense of the invention, a locking system with extended possibilities can be provided in combination with the existing lock, as in modern locking systems with fixed handles. The retrofit system is simple and can be easily and intuitively mounted on the movable part.

However, even in vehicles with fixed handles, the locking system in the sense of the invention may be advantageous as a retrofit system to overcome the problem in an emergency if the vehicle battery is discharged and/or the electronic system fails, in order to enable the mechanical actuation of the lock by means of the fixed handle in the sense of the invention. The handle may be fixed in relation to the movable part during normal operation of the vehicle and may be provided with an emergency opening function in case of an emergency in order to be able to open the movable part by mechanical actuation, i.e. by moving the handle. For this purpose, a threshold limit for the actuating force may be provided in order to intercept a transmission of the actuating force, e.g. a tensile force, from the actuator to the handle below the threshold limit (normal operation) and/or to permit a transmission of the actuating force, e.g. a tensile force, from the handle to the lock above the threshold limit (emergency operation). An overload coupling between the lock and the fixed handle can be provided for this purpose.

Furthermore, in the case of a locking system, the invention may provide that the actuator can be arranged on the movable part. The actuator can be mounted directly on the movable part and spatially independent of the lock. This considerably simplifies the installation and creates flexibility in the selection of the fixing location.

Furthermore, in the case of a locking system, the invention may provide that the locking system is designed as part of a keyless-go system or a keyless-entry system. Such systems provide a special comfort for the authorized user or driver, who can be relieved in the broadest sense when actuating the lock. Such systems recognize the user, check his authorization and operate the lock without any active intervention. Such systems can also release the movable part for an opening movement or even open it automatically if the movable part can be moved into the opening position, e.g. spring elastically.

Furthermore, the invention may provide that the locking system can be brought into a communication connection with a security system of the vehicle, which queries an authorization of a user (identification request) in order to be able to actuate the handle. Thus, an extended functionality of the locking system can be provided by means of the invention. For this purpose, corresponding sensors can be provided in the handle which can recognize an approach of a user, which can then trigger the identification request and which can also recognize an opening intention of the user. It is conceivable that the locking system can activate the security system of the vehicle to perform the identification request. Nevertheless, it is conceivable that the locking system may comprise its own electronic unit within the scope of the invention, which can itself perform the identification request. The electronic unit can be installed in the handle, for example.

The lock within the scope of the invention may be designed for automatic locking and/or unlocking and for automatic opening and/or closing of the movable part. This allows advantageously an uninterrupted unlocking of the movable part and/or a subsequent opening of the movable part and in a reverse direction a closing and/or a subsequent locking of the movable part.

In addition, in the case of a locking system, the invention may provide that the handle comprises an electronic unit which is in a, preferably wireless, communication connection with the actuator to trigger an actuation of the lock. Thus, an automatic actuation of the lock can be enabled.

Furthermore, in the case of a locking system, the invention may provide that the electronic unit can be brought into a communication connection with a security system of the vehicle, which queries an authorization of a user in order to actuate the handle. Thus, a self-contained, autonomous system can be provided within the scope of the locking system according to the invention, which can provide all functions of a keyless-go system or a keyless-entry system.

Furthermore, the invention can provide in a locking system that at least one first, in particular capacitive, sensor element is provided for monitoring at least one first activation region of the locking system in order to detect an approach and/or a touch of the handle and/or at least one first movement pattern or a second movement pattern by a hand of the user in the first activation region. It is conceivable that the handle, in particular the electronic unit, comprises the at least one first sensor element. However, it is also conceivable that the at least one first sensor element is arranged at a distance from the handle on the movable part. In addition, it is conceivable that the first activation region is present on an outer side of the handle facing away from the movable part. The first sensor element can be used to recognize a user near the handle. This allows the locking system to be used with different security systems.

Furthermore, the invention may provide in a locking system that at least one second, in particular capacitive, sensor element is provided for monitoring at least one second activation region of the locking system in order to detect an approach and/or a touch of the handle and/or an engagement behind the handle by a hand of the user in the second activation region. The second sensor element can be used to recognize an opening intention of the movable part. It is conceivable that the handle, in particular the electronic unit, comprises the at least one second sensor element. However, it is also conceivable that the at least one second sensor element is arranged at a distance from the handle on the movable part, for example in a recessed grip. It is also conceivable that the second activation region is present on an outer side of the handle facing the movable part. This allows a flexible use of the locking system with different security systems.

In addition, the invention may provide in a locking system that at least one third, in particular capacitive, sensor element is provided for monitoring at least one third activation region of the locking system in order to detect an approach and/or a touch of the handle in the third activation region. It is conceivable that the handle, in particular the electronic unit, comprises the at least one third sensor element. However, it is also conceivable that the at least one third sensor element is arranged on the movable part at a distance from the handle. It is also conceivable that the third activation region is formed on an upper narrow side of the handle. The third sensor element can be used to recognize a locking intention of the movable part. Thus, the user can comfortably lock the movable part after closing it.

In addition, the invention may provide, in the case of a locking system, that the lock is connected to the actuator via a transmission element, in particular operatively connected via an actuating lever, in order to actuate the lock during normal operation of the vehicle. Thus, a comfortable, in particular automatic actuation of the lock during normal operation of the vehicle can be enabled (without having to move the handle).

Furthermore, in the case of a locking system, the invention may provide that the lock is connected to the handle via the transmission element and in particular an overload coupling in order to actuate the lock in an emergency operation of the vehicle. Thus, a safe, in particular mechanical, actuation of the lock in emergency operation of the vehicle can be enabled.

Furthermore, the invention may provide in a locking system that a transmission element is provided between the handle, the lock and the actuator in order to transmit an actuating force between the handle, the lock and the actuator, in particular a tensile force from the handle and/or from the actuator to the lock. Thus, an effective transmission of the actuating force over a spatial distance can be advantageously enabled. This allows preferably a flexible transmission chain of the actuating force between the actuator, the lock and the handle.

Furthermore, the invention may provide in a locking system that an overload coupling is provided between the handle and the transmission element, in particular between the handle and a core of the transmission element, preferably in the form of a, preferably spring elastically, storage element, in order to intercept a transmission of a tensile force from the actuator to the handle below a threshold limit and/or to permit a transmission of a tensile force from the handle to the lock above the threshold limit, in particular to allow an automatic actuation of the lock by means of the actuator in a normal operation of the vehicle and/or mechanical actuation of the lock by means of the handle in an emergency operation of the vehicle. This is a useful way of separating the normal operation and the emergency operation of the vehicle without interrupting the transmission chain of the actuating force between the actuator, the lock and the handle.

In addition, the invention may provide in a locking system that the transmission element is in the form of a Bowden cable. A Bowden cable is a low-cost component which can be laid flexibly, even over bends, and which enables the transmission of a tensile force over spatial distances.

In addition, the invention may provide, in the case of a locking system, that the transmission element comprises a core which extends, in particular continuously, between the handle, the lock and the actuator and via which a mechanical operative connection for transmitting an actuating force between the handle, the lock and the actuator can be produced. The core preferably forms the element which extends without interruptions between the handle, the lock and the actuator and which engages at one end on the handle and at another end on the actuator to absorb the actuating force. The operative connection of the transmission element to the lock is produced on an actuating lever of the lock, which is fixed to a first sleeve section of the transmission element. The operative connection of the core of the transmission element to the lock is thus produced via the first sleeve section of the transmission element.

According to an advantage of the invention, the transmission element can comprise a sleeve of at least two parts lengthwise. Within the scope of the invention it is conceivable that the transmission element comprises a first sleeve section between the handle and the lock and a second sleeve section between the lock and the actuator. In addition, it may be advantageous if the first sleeve section is mounted movably relative to the second sleeve section. Thus, it can be enabled that the length change during the movement of the core is compensated by the movement of the first sleeve section. It is conceivable that the second sleeve section between the lock and the actuator is essentially immovably mounted or is fixedly supported on both sides by the side of the actuator and by the side of the lock. The core of the transmission element moves within the second sleeve section. It is also conceivable that the first sleeve section is fixed to an actuating lever of the lock from the side of the lock by means of a sleeve and can be moved along with the actuating lever. From the side of the handle, the first sleeve section can be supported fixedly by means of a sleeve. In this way, during a normal operation of the vehicle, the first sleeve section can at least partially follow the movement of the core of the transmission element in the same direction when the core is tensioned within the first sleeve section. In an emergency operation the sleeve can be moved in the opposite direction to the movement of the core of the transmission element when the core is tensioned within the first sleeve section. In other words, a tension of the core from different sides (of the actuator or the handle) can be translated into the movement of the first sleeve section on the lock side in the same direction.

Furthermore, the invention may provide in a locking system that the transmission element, in particular between the first sleeve section and the second sleeve section, comprises a pond. The pond can advantageously compensate the length change during the movement of the core or the relative movement of the sleeve sections to each other.

Furthermore, the invention can provide in a locking system that the transmission element, in particular between the first sleeve section and the second sleeve section, preferably at the pond, comprises a collar. In addition, it is conceivable that the collar is elastically deformable and/or is designed bellows-like in order to enable a movement of the first sleeve section relative to the second sleeve section, which can be carried out, in particular in a normal operation of the vehicle in the same direction and/or in an emergency operation of the vehicle in the opposite direction with or to the movement of the core of the transmission element. The collar can preferably cover the pond in order to guide the core of the transmission element in a protected manner.

Furthermore, the invention may provide in a locking system that the lock comprises an actuating lever on which the transmission element, in particular the first sleeve section of the transmission element, engages. Thus, an operative connection between the transmission element, in particular the core movable by the actuator or the handle, and the lock can be provided via the first sleeve section. Furthermore, it is advantageous that the actuating force can be absorbed by the core of the transmission element both from the side of the actuator and from the side of the handle as a tensile force. During normal operation of the vehicle, the tensile force of the actuator on the core of the transmission element can be converted into the movement of the first sleeve section in the same direction. In emergency operation of the vehicle, the tensile force on the core of the transmission element can be converted from the handle into the movement of the first sleeve section in the opposite direction. It is advantageous that the tensile force at the core is converted from different sides (of the actuator or the handle) into the movement of the first sleeve section at the lock side in the same direction. In this way, the lock, in particular the actuating lever of the lock, can always be actuated in the same direction when tensioning the core of the transmission element.

It is also conceivable that the actuating lever may be moved, in particular rotated, at least between two positions, namely: a resting position in which the lock is not actuated or the movable part is locked, and an actuating position in which the lock is actuated or the movable part is unlocked. It is advantageous that, by moving the core of the transmission element longitudinally in different directions, two positions can always be obtained in order to actuate the lock in the same direction to lock and/or unlock the movable part. Advantageously, a tensile force applied to the core, either by the actuator or by the handle, can be converted into the movement of the actuating lever in the direction from the resting position to the actuating position.

Furthermore, the invention may provide in a locking system that the actuating lever comprises a fixing fork which is connected to the first sleeve section of the transmission element in a form and/or force-locking manner. Thus, the fixing fork can indirectly tap the actuating force when tensioning the core via the first sleeve section.

Furthermore, the invention can provide, in a locking system, that the first sleeve section is fixed to the actuating lever by means of a sleeve in a form and/or force-locking, preferably releasable, manner, which in particular can be moved along with the actuating lever, and/or the fixing fork is fixed in a form and/or force-locking manner with a fixing section to a sleeve on the first sleeve section of the transmission element. Thus, the first sleeve section can move with the actuating lever. From the side of the handle, the first sleeve section can be supported fixedly on the movable part, preferably within a bearing bracket of the handle, by means of a sleeve. This allows the first sleeve section to tighten when the core is tensioned. This in turn causes the first sleeve section to move with the actuating lever, regardless of the side from which the tensile force is introduced into the core.

Furthermore, the invention can provide in a locking system that the lock comprises a clamping mechanism to which the transmission element is fixed, preferably releasably, in particular in the region between the second sleeve section and/or the collar of the transmission element. A fixed support for the second sleeve section can be provided at this point.

In addition, the invention may provide that the second sleeve section is fixed to the clamping mechanism in a form and/or force-locking manner and/or the clamping mechanism comprises a clamping element which can be brought into a form and/or force-locking connection with a complementary clamping element to a sleeve on the second sleeve section of the transmission element. Thus, the transmission element can be supported on the lock by means of the clamping mechanism in order to enable a stable transmission of the actuating force.

Furthermore, the invention may advantageously provide that the locking system is designed in the form of a retrofit kit. Thus, vehicles with different handles can be retrofitted to provide increased comfort and increased security in the sense of the invention.

It is also conceivable that the actuator comprises a motor and a gear. Thus, the transmission force can be obtained from the electric power of the motor and converted into the movement of the transmission element by means of the gear.

It may also be advantageous for the actuator to comprise a coil for winding a core of the transmission element. Thus, the core can be unwound or wound on the coil when the lock is actuated, depending on the direction in which the actuating force is transmitted.

In addition, the object according to the invention is solved by a method for operating a locking system of a movable part, in particular a door or a lid, of a vehicle, wherein the locking system can be executed in particular as described above. The locking system may comprise a handle fixed relative to the movable part in a normal operation of the vehicle for opening or closing the movable part, a lock for locking or unlocking the movable part and an actuator for actuating the lock, in particular to open the movable part. The method comprises the following steps:
a) automatic actuation of the lock by means of the actuator in a normal operation of the vehicle, or
b) mechanical actuation of the lock by means of the handle in an emergency operation of the vehicle.

With the help of the method according to the invention, the same advantages are achieved as described above in connection with the locking system according to the invention. In order to avoid repetition, full reference is made to this in the present case.

Further advantages, features and details of the invention result from the following description in which, with reference to the figures, embodiments of the invention are described in detail.

The features mentioned in the claims and in the description may be individually or in any combination essential to the invention. The figures show:

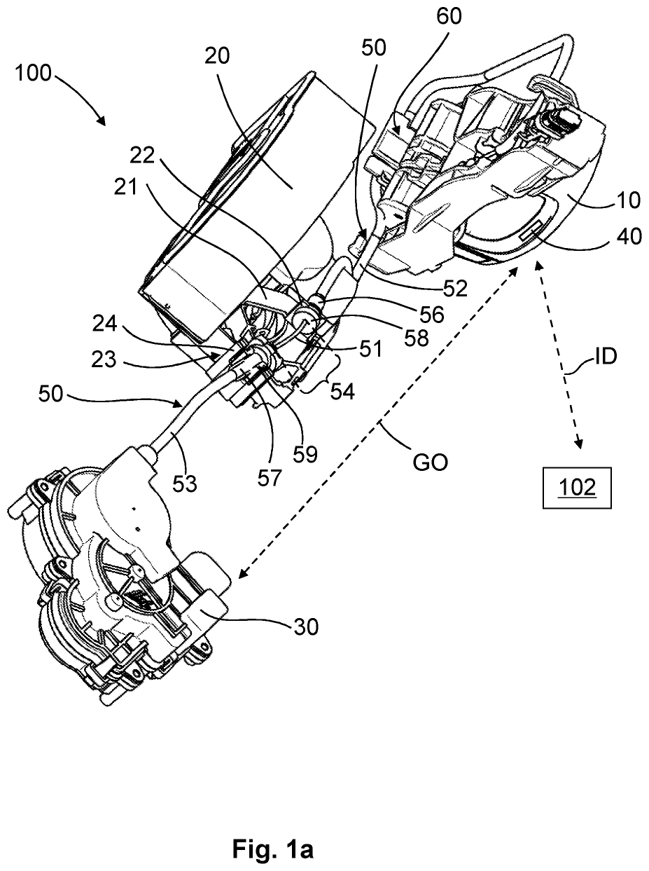

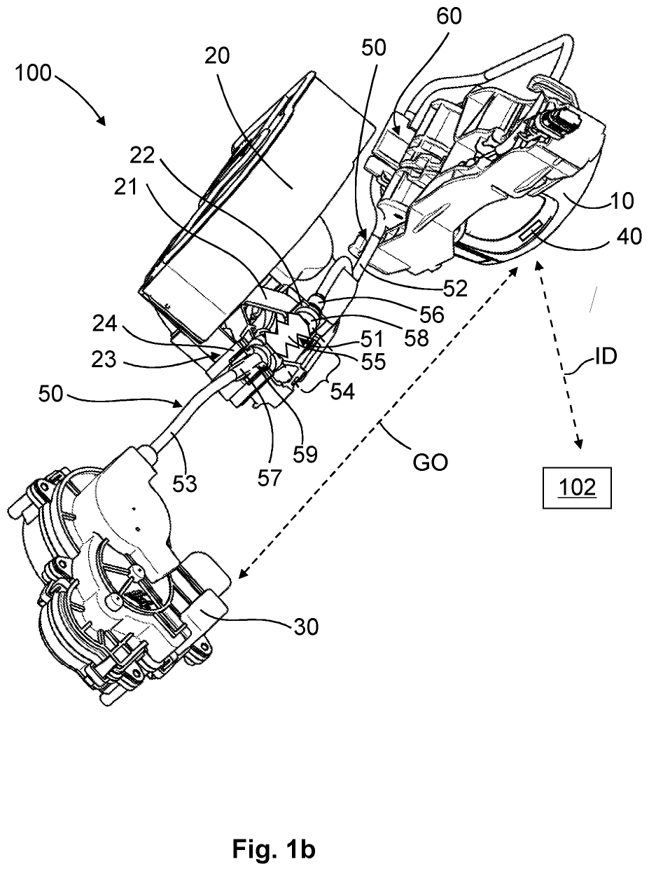

FIG. 1a a schematic representation of a locking system in the sense of the invention,

FIG. 1b a further schematic representation of a locking system in the sense of the invention,

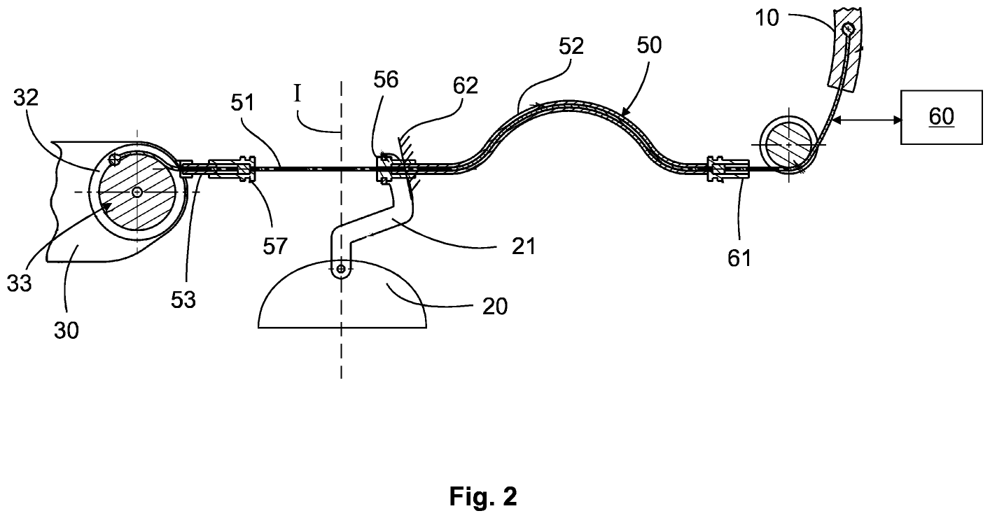

FIG. 2a schematic representation of a transmission element in the sense of the invention in a resting position of an actuating lever of a lock,

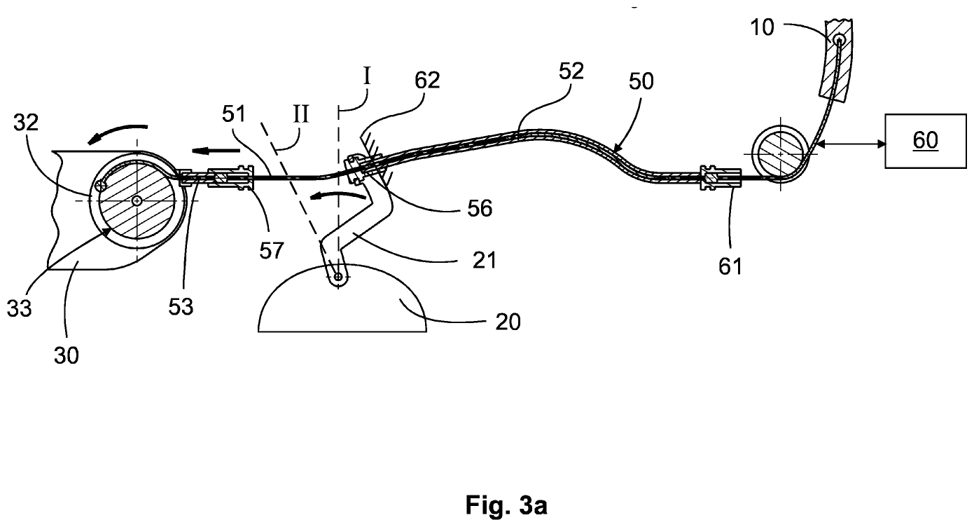

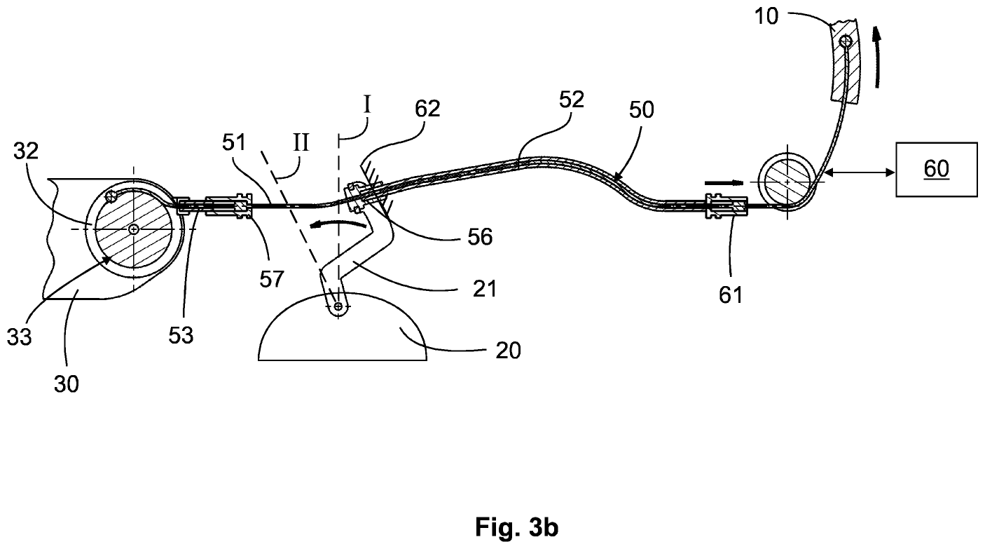

FIG. 3a a schematic representation of a transmission element in the sense of the invention in an actuating position of an actuating lever of a lock when an actuator is actuated,

FIG. 3b a schematic representation of a transmission element in the sense of the invention in an actuating position of an actuating lever of a lock when a handle is pulled,

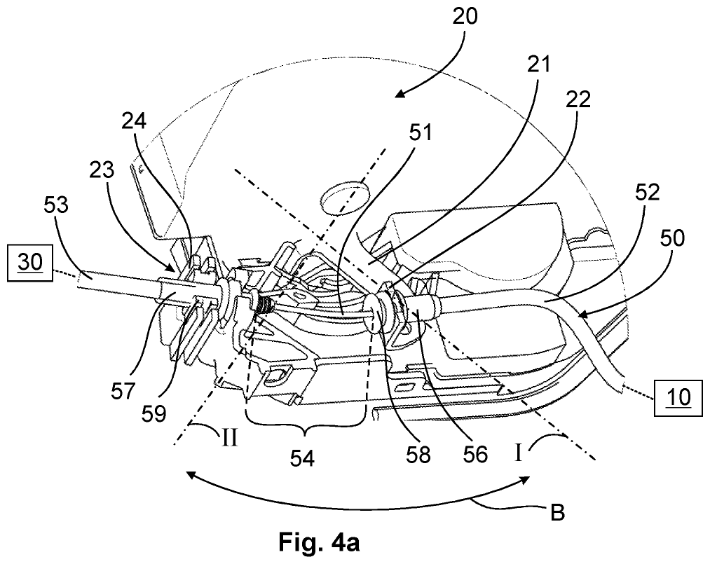

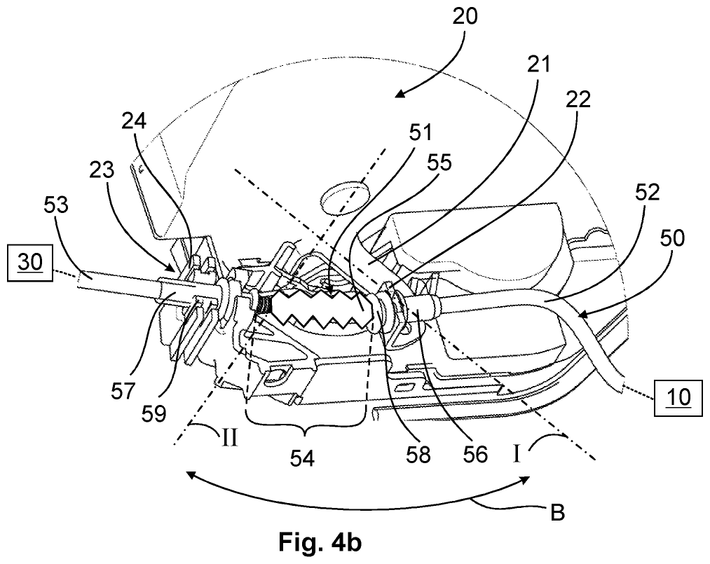

FIG. 4a an enlarged representation of a locking system in the sense of the invention in the region of a lock,

FIG. 4b a further enlarged representation of a locking system in the sense of the invention in the region of a lock,

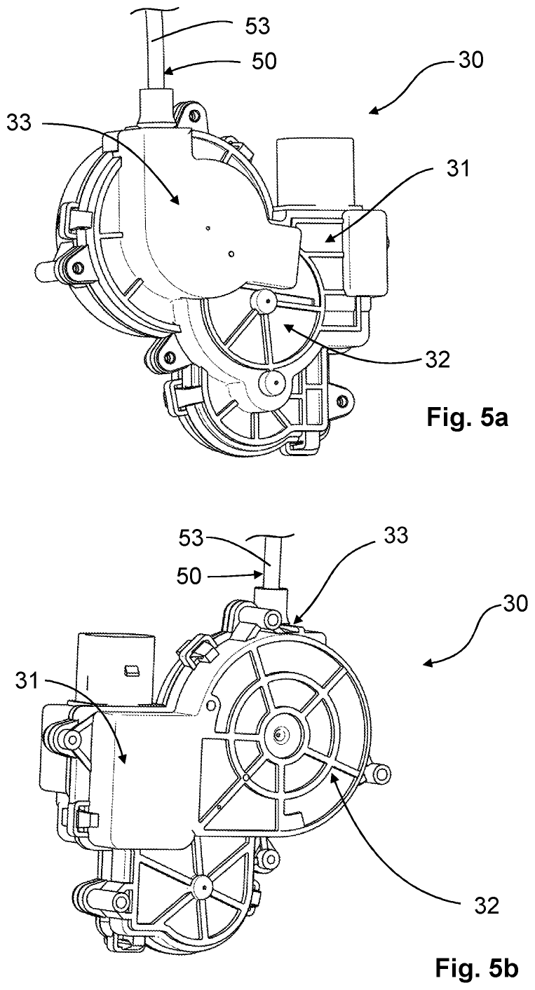

FIG. 5a a view of a lock of a locking system in the sense of the invention,

FIG. 5b a further view of a lock of a locking system in the sense of the invention,

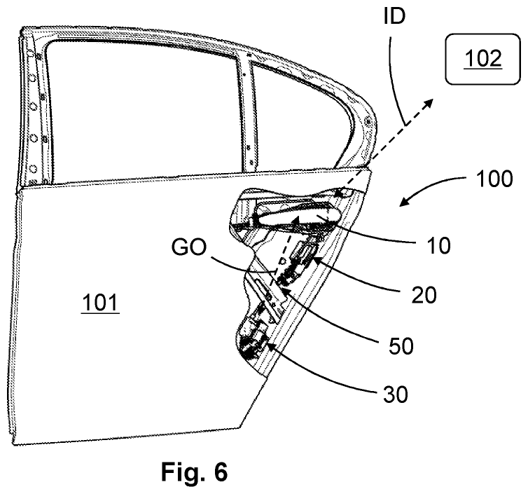

FIG. 6 an installation possibility of a locking system in the sense of the invention on a vehicle door,

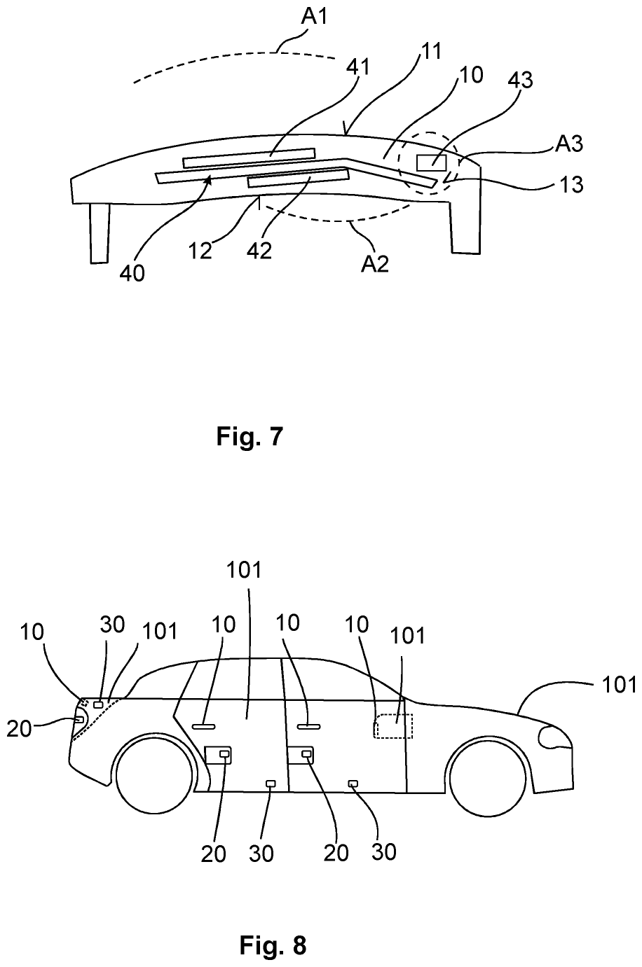

FIG. 7a schematic representation of a handle in the sense of the invention, and

FIG. 8 schematic installation possibilities of a locking system in terms of the invention on a vehicle.

The reference signs are usually described only once and apply in connection with all figures and embodiments of the invention.

FIGS. 1a and 1b show a locking system 100 in the sense of the invention, which can be used for different movable parts 101, e.g. doors or lids (see FIG. 8 below), of a vehicle. The locking system 100 comprises a handle 10, which in a normal operation of the vehicle is fixed relative to the movable part 101 for opening or closing the movable part 101, a lock 20 for locking or unlocking the movable part 101 and an actuator 30 for actuating the lock 20. According to the invention, the actuator 30 can be arranged at a distance from the lock 20, in particular directly on the movable part 101.

The locking system 100 in the sense of the invention may serve as an automatically controllable system that can communicate with a security system 102 of the vehicle (see FIGS. 1a, 1b and 6) to request an authorization of a user to open the movable part 101. The locking system 100 can thus form part of a keyless-go system or a keyless-entry system. The locking system 100 is advantageously designed to automatically open and/or close the movable part 101. The actuator 30 is provided for this purpose. The actuator 30 can actuate the lock 20 accordingly. As shown in FIGS. 5a and 5b, the actuator 30 comprises a motor 31 which can be controlled by electric signals, e.g. of an electronic unit 40 (see FIGS. 1a, 1b and 7). The electric signals can be transmitted advantageously wirelessly, e.g. by means of electromagnetic waves, preferably by radio.

Due to the spatially separated arrangement of the actuator 30 to the lock 20, the actuator 30 can be provided as a separate unit which does not need to be installed in the housing of the lock 20. As shown in FIG. 6 below, the actuator 30 can be fixed at a remote location. By structurally separating it from the actuator 30, an advantageously simple and inexpensive mechanical lock 20 can be used as part of the locking system 100 according to the invention. A preferably flexible transmission chain is formed between the actuator 30, the lock 20 and the handle 10, e.g. by means of a flexible transmission element 50, e.g. in the form of a Bowden cable. According to a particular advantage of the invention, the locking system 100 can provide the advantages of the fixed handle 10 in a normal operation of the vehicle and at the same time a safe, in particular mechanical, emergency opening function in an emergency with the same handle 10.

Furthermore, it is an advantage that the locking system 100 in the sense of the invention can be used as a retrofit system for vehicles which already comprise mechanical locks 20 and movable handles 10. By retrofitting the actuator 30 and the fixed handle 10 in the sense of the invention, a locking system 100 with extended possibilities can be provided in combination with the existing mechanical lock 20. The retrofit system is simple in design and can be easily and intuitively mounted on the movable part, as shown in FIGS. 6 and 8 below.

However, even in vehicles equipped with fixed handles 10, the locking system 100 may be advantageous in the sense of the invention as a retrofit system or retrofit kit to enable mechanical actuation of the lock 20 by means of the fixed handle 10 in the sense of the invention in an emergency. The handle 10 may be fixed relative to the movable part 101 during normal operation of the vehicle and may be provided with an emergency opening function in case of an emergency in order to be able to open the movable part 101 by mechanical actuation, i.e. by moving the handle 10. For this purpose, a threshold limit for the actuating force may be provided in order to intercept a transmission of the actuating force, e.g. a tensile force, from the actuator to the handle below this threshold limit (normal operation) and/or to permit a transmission of the actuating force, e.g. a tensile force, from the handle to the lock above the threshold limit (emergency operation). For this purpose, an overload coupling 60 can be provided between the lock 20 and the fixed handle 10, for example, which is indicated schematically in FIGS. 1a, 1b, 2, 3a and 3b. A spring element is conceivable as an overload coupling 60, which can temporarily store the tensile force up to a certain threshold limit. Furthermore, a hydraulic cylinder, a drive or the like is conceivable as an overload coupling 60.

As FIGS. 1a and 1b further indicate, the locking system 100 can be brought in a communication connection ID to the vehicle's security system 102, e.g. by means of the electronic unit 40 (see also FIG. 7). The communication connection ID is used to request the authorization of a user or to carry out an identification request in order to be allowed to actuate the handle 10.

As shown in FIGS. 1a, 1b and 7, the handle 10 comprises an electronic unit 40, which can be exemplarily arranged inside a cavity inside the handle 10 and which can be, if necessary, sealed with a sealing compound. The electronic unit 40 can establish a, preferably wireless, communication connection GO with the actuator 30 in order to control the actuation of the lock 20 during normal operation of the vehicle. A prerequisite for actuating the lock GO can be a positive authorization request of a user. After a positive authorization request, unlocking of the lock 20 can be initiated, for example, by the vehicle's security system 102. After unlocking the lock 20, the locking system 100 according to the invention uses the lock 20 to open the movable part 101. This enables an automatic actuation of the lock 20.

As further shown in FIG. 7, the handle 10, in particular the electronic unit 40, may comprise a first, in particular capacitive, sensor element 41 for monitoring at least one first activation region A1 of the locking system 100 in order to detect an approach and/or a touch of the handle and/or at least one first movement pattern or a second movement pattern by a hand of the user in the first activation region A1. The first activation region A1 may be present on an outer side 11 of the handle 10 facing away from the movable part 101. The first sensor element 41 can recognize the presence of a user near the handle 10.

Furthermore, the handle 10, in particular the electronic unit 40, can comprise a second, in particular capacitive, sensor element 42 for monitoring at least one second activation region A2 of the locking system 100 in order to detect an approach and/or a touch of the handle 10 and/or an engagement behind the handle 10 by a hand of the user in the second activation region A2. The second activation region A2 may be present on an outer side 12 of the handle 10 facing the movable part 101 as indicated in FIG. 7. The second sensor element 42 can be used to recognize an opening intention of the movable part 101.

In addition, the handle 10, in particular the electronic unit 40, can comprise a third, in particular capacitive, sensor element 43 for monitoring at least one third activation region A3 of the locking system 100 in order to detect an approach and/or a touch, e.g. a tap, of the handle 10 in the third activation region A3. The third activation region A3 can be formed on an upper narrow side 13 of the handle 10 as indicated in FIG. 7. The third sensor element 43 can be used to recognize a locking intention of the movable part 101.

As can also be seen from FIGS. 1a to 6, the lock 20 is connected to the actuator 30 via a transmission element 50 in order to be able to automatically actuate the lock 20 during normal operation of the vehicle.

At the same time, the lock 20 is connected to the handle 10 via the same transmission element 50 and in particular an overload coupling 60, in order to be able to actuate the lock 20 mechanically in an emergency operation of the vehicle.

As shown in FIGS. 1a to 4b, the transmission element 50 extends between the handle 10, the lock 20 and the actuator 30 to transmit an actuating force between the handle 10, the lock 20 and the actuator 30, e.g. a pulling force from the handle 10 and/or the actuator 30 to the lock 20.

As can be seen in FIGS. 1a and 4b, the transmission element 50 can be designed in the form of a Bowden cable. The transmission element 50 may comprise a core 51 extending, in particular continuously, between the handle 10, the lock 20 and the actuator 30, by means of which a mechanical operative connection is produced for transmitting an actuating force between the handle 10, the lock 20 and the actuator 30.

As shown in FIGS. 2, 3a and 3b, the operative connection of the transmission element 50 to the lock 20 is produced on an actuating lever 21 of the lock 20, which is fixed to a first sleeve section 52 of the transmission element 50 by means of a sleeve 56 movable with the first sleeve section 52. FIG. 2 shows the actuating lever 21 in a resting position I.

As FIGS. 1a to 4b also show, the transmission element 50 can comprise a sleeve 52, 53, which is at least in two parts lengthwise. The transmission element 50 can comprise a first sleeve section 52 between the handle 10 and the lock 20 and a second sleeve section 53 between the lock 20 and the actuator 30.

As can be seen from FIGS. 3a and 3b, the first sleeve section 52 of the transmission element 50 is mounted movably relative to the second sleeve section 53 in order to compensate for the length change during movement of the core 51 via the movement of the first sleeve section 52.

As can be seen in FIGS. 2, 3a and 3b, the second sleeve section 53 between the lock 20 and the actuator 30 is essentially immovably mounted, or is supported fixedly on both sides from the side of the actuator 30 and by the side of the lock 20. From the side of the lock 20 a fixed sleeve 57 is provided. The core 51 of the transmission element 50 can move within the second sleeve section 53.

As FIGS. 2, 3a and 3b further show, the first sleeve section 52 is fixed to the actuating lever 21 of the lock 20 from the side of the lock 20 by means of a sleeve 56 and can therefore move with the actuating lever 21. From the side of the handle 10, the first sleeve section 52 is supported fixedly by a sleeve 61, e.g. in a bearing bracket of the handle 10.

As shown in FIG. 3a, in a normal operation of the vehicle, the first sleeve section 52 can at least partially follow the movement of the core 51 of the transmission element 50 in the same direction when the core 51 is tensioned within the first sleeve section 52.

As FIG. 3b again shows, in an emergency operation of the vehicle, the sleeve 56 can be moved in the opposite direction to the movement of the core 51 of the transmission element 50, if the core 51 is tensioned within the first sleeve section 52.

As FIGS. 3a and 3b indicate, a tension on the core 51 from different sides (of the actuator 30 or the handle 10) can be translated into movement of the first sleeve section 52 on the lock side (i.e. the sleeve 56) in the same direction between the resting position I and an actuating position II of the actuating lever 21. Within the scope of the invention, the movement of the actuating lever 21 can be enabled between the resting position I and the actuating position II, e.g. by a forced guidance not shown for reasons of simplicity. The movement of the actuating lever 21 beyond the resting position I can be limited by a fixed stop 62 against which the sleeve 56 can be brought into contact.

A pond 54 may be provided between the first sleeve section 52 and the second sleeve section 53. The pond 54 can advantageously compensate the length change during the movement of the core 51 or the relative movement of the sleeve sections 52, 53 to each other.

The pond 54 may also comprise a collar 55 (see FIGS. 1b and 4b) to cover the core 51. The collar 55 may be elastically deformable, e.g. bellows-like, to allow a movement of the first sleeve section 52 relative to the second sleeve section 53.

As can be seen in FIGS. 4a and 4b, the lock 20 comprises an actuating lever 21 to which the transmission element 50, in particular the first sleeve section 52 of the transmission element 50, is fixed in a form and/or force-locking manner.

Furthermore, FIGS. 4a and 4b show that the actuating lever 21 can be moved between two positions I, II, in particular rotated (see the movement direction B in FIGS. 4a and 4b). The positions I, II can comprise a resting position I, in which the lock 20 is not actuated or the movable part 101 is locked, and an actuating position II, in which the lock 20 is actuated or the movable part 101 is unlocked. These positions I, II are shown schematically in FIGS. 2, 3a, 3b, 4a and 4b.

As FIGS. 4a and 4b also illustrate, a fixing fork 22 is formed at the end of the actuating lever 21, which can engage between the first sleeve section 52 and the pond 54 of the transmission element 50. The first sleeve section 52 can be fixed to the actuating lever 21 in a form and/or force-locking manner using the fixing fork 22. In doing so, the fixing fork 22 can be fixed in a form and/or force-locking manner with a fixing section 58 on the sleeve 56 to the first sleeve section 52 of the transmission element 50 so that the first sleeve section 52 can move with the actuating lever 21.

Furthermore, the lock 20 may comprise a clamping mechanism 23 to which the second sleeve section 53 of the transmission element 50, in particular in the region between the second sleeve section 53 and/or the collar 55 of the transmission element 50, is fixed, preferably releasably. At this point a fixed support for the second sleeve section 53 can be provided on the housing of the lock 20.

Advantageously, the second sleeve section 53 can be fixed in a form and/or force-locking manner to the clamping mechanism 23, wherein the clamping mechanism 23 can comprise a clamping element 24 which can be fixed in a form and/or force-locking manner to the second sleeve section 53 of the transmission element 50 by means of a complementary clamping element 59 on a sleeve 57. Thus, the transmission element 50 can be supported on the lock 20 by means of the clamping mechanism 23 to enable a stable transmission of the actuating force via the transmission element 50.

As mentioned above, the actuator 30 can comprise a motor 31 and a gear 32, as shown in FIGS. 5a and 5b. Furthermore, the actuator 30 can comprise a coil 33 for winding a core 51 of the transmission element 50 (see also FIGS. 2, 3a and 3b). Thus, when actuating the lock 20, the core 51 can be at least partially unwound or wound onto the coil 33, depending on the direction in which the actuating force is transmitted.

FIG. 6 shows an embodiment according to which the locking system 100 can be installed on a vehicle door. According to FIG. 8, it can be seen that the locking system 100 in the sense of the invention can be installed not only on a vehicle door, but also on a vehicle lid, on a hood or even on a hinged side mirror in order to achieve the advantages according to the invention.

The above description of the figures describes the present invention exclusively in the context of examples. Of course, individual features of the embodiments can be freely combined with each other, provided it is technically reasonable, without leaving the scope of the invention.

### LIST OF REFERENCE SIGNS

10 handle
11 outer side
12 outer side
13 narrow side
20 lock
21 actuating lever
22 fixing fork
23 clamping mechanism
24 clamping element
30 actuator
31 motor
32 gear
33 coil
40 electronic unit
41 first sensor element
42 second sensor element
43 third sensor element
50 transmission element
51 core
52 first sleeve section
53 second sleeve section
54 pond
55 collar
56 sleeve
57 sleeve
58 fixing section
59 complementary clamping element
60 overload coupling
61 sleeve
62 stop
100 locking system
101 movable part
102 security system
A1 first activation region
A2 second activation region
A3 third activation region
GO communication connection
ID communication connection
I resting position
II actuating position
B movement direction

1-18. (canceled)

19. A locking system for a movable part of a vehicle, comprising:
a handle fixed relative to the movable part in a normal operation of the vehicle for opening or closing the movable part,
a lock for locking or unlocking the movable part,
and an actuator for actuating the lock,
wherein
the actuator can be arranged at a distance from the lock.

20. The locking system according to claim 19,
wherein
the actuator can be arranged on the movable part.

21. The locking system according to claim 19,
wherein
at least the locking system is designed as part of a keyless-go system or a keyless-entry system,
or the locking system can be brought into a communication connection with a security system of the vehicle, which queries an authorization of a user in order to be able to actuate the handle,
or the lock is designed for at least automatic locking or unlocking and for at least automatic opening or closing of the movable part.

22. The locking system according to claim 19,
wherein
at least the handle comprises an electronic unit which is in a communication connection with the actuator to trigger an actuation of the lock
or the electronic unit can be brought into a communication connection with a security system of the vehicle, which queries an authorization of a user in order to actuate the handle.

23. The locking system according to claim 19,
wherein
at least one first sensor element is provided for monitoring at least one first activation region of the locking system in order to detect at least an approach or a touch of the handle or at least one first movement pattern or a second movement pattern by a hand of the user in the first activation region,
or the first activation region is present on an outer side of the handle facing away from the movable part.

24. The locking system according to claim 19,
wherein
at least one second sensor element is provided for monitoring at least one second activation region of the locking system in order to detect at least an approach or a touch of the handle or an engagement behind the handle by a hand of the user in the second activation region,
or the second activation region is present on an outer side of the handle facing the movable part.

25. The locking system according to claim 19,
wherein
at least one third sensor element is provided for monitoring at least one third activation region of the locking system in order to detect at least an approach or a touch of the handle in the third activation region,
or the third activation region is formed on an upper narrow side of the handle.

26. The locking system according to claim 19,
wherein
at least the lock is connected to the actuator via a transmission element in order to actuate the lock during normal operation of the vehicle,
or the lock is connected to the handle via the transmission element in order to actuate the lock in an emergency operation of the vehicle.

27. The locking system according to claim 19,
wherein
at least a transmission element is provided between the handle, the lock and the actuator in order to transmit an actuating force between the handle, the lock and the actuator,
or an overload coupling is provided between the handle and the transmission element
in order to at least intercept a transmission of a tensile force from the actuator to the handle below a threshold limit or to permit a transmission of a tensile force from the handle to the lock above the threshold limit.

28. The locking system according to claim 19,
wherein
at least the transmission element is in the form of a Bowden cable,
or the transmission element comprises a core which extends between the handle, the lock and the actuator and via which a mechanical operative connection for transmitting an actuating force between the handle, the lock and the actuator can be produced.

29. The locking system according to claim 19,
wherein
at least the transmission element comprises a sleeve of at least two parts lengthwise, or the transmission element comprises a first sleeve section between the handle and the lock and a second sleeve section between the lock and the actuator,
or the first sleeve section is mounted movably relative to the second sleeve section.

30. The locking system according to claim 19,
wherein
at least the transmission element comprises a pond,
or the transmission element comprises a collar
or the collar is at least elastically deformable or is designed bellows-like.

31. The locking system according to claim 19,
wherein
at least the lock comprises an actuating lever on which the transmission element engages,
or the actuating lever can be moved at least between two positions, namely:
a resting position in which the lock is not actuated,
and an actuating position in which the lock is actuated.

32. The locking system according to claim 19,
wherein
at least the actuating lever comprises a fixing fork which is connected to the first sleeve section of the transmission element in at least a form or force-locking manner,
or the first sleeve section is fixed to the actuating lever by means of a sleeve in at least a form or force-locking manner,
or the fixing fork is fixed in at least a form or force-locking manner with a fixing section to a sleeve on the first sleeve section of the transmission element,
or the first sleeve section can be supported fixedly from the side of the handle on the movable part by means of a sleeve.

33. The locking system according to claim 19,
wherein
at least the lock comprises a clamping mechanism to which the transmission element is fixed,
or the second sleeve section is fixed to the clamping mechanism in at least a form or force-locking manner by means of a sleeve,
or the clamping mechanism comprises a clamping element, which is fixed in at least a form or force-locking manner with a complementary clamping element to a sleeve on the second sleeve section of the transmission element.

34. The locking system according to claim 19,
wherein
the locking system is designed as a retrofit kit.

35. The locking system according to claim 19,
wherein
at least the actuator comprises a motor and a gear,
or the actuator comprises a coil for winding a core of the transmission element.

36. A method for operating a locking system of a movable part of a vehicle comprising:
a handle fixed relative to the movable part in a normal operation of the vehicle for opening or closing the movable part,
a lock for locking or unlocking the movable part,
and an actuator for actuating the lock,
wherein
the method comprises the following steps:
(a) automatic actuation of the lock by means of the actuator in a normal operation of the vehicle, or
(b) mechanical actuation of the lock by means of the handle in an emergency operation of the vehicle.
